(19) United States
(12) Patent Application Publication
(10) Pub. No.: US 2025/0096866 A1
(43) Pub. Date: Mar. 20, 2025

(54) METHODS, DEVICES, AND COMPUTER READABLE MEDIUM FOR COMMUNICATION

(71) Applicant: NEC CORPORATION, Tokyo (JP)

(72) Inventors: Gang WANG, Beijing (CN); Peng GUAN, Beijing (CN)

(73) Assignee: NEC CORPORATION, Tokyo (JP)

(21) Appl. No.: 18/725,640

(22) PCT Filed: Dec. 31, 2021
(86) PCT No.: PCT/CN2021/143739

§ 371 Date: Jun. 28, 2024

(51) Int. Cl. H04B 7/06

(52) U.S. Cl. CPC H04B 7/0626; H04B 7/0632; H04B 7/0639

(57) ABSTRACT

Embodiments of the present disclosure relate to methods, devices, and computer readable medium for communication. According to embodiments of the present disclosure, a terminal device receives downlink information for triggering a report from a network device. The terminal device determines whether an inference failure occurs in a data processing model. The terminal device transmits the report to the network device. The report indicates whether the inference failure occurs in the data processing model and/or whether information in the report is generated based on the data processing model. In this way, the network device can be informed about the inference failure, thereby improving accuracy of information transmitted by the terminal device.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances.

### SUMMARY

In general, example embodiments of the present disclosure provide a solution for communication.

In a first aspect, there is provided a method for communication. The communication method comprises: receiving, at a terminal device and from a network device, downlink information for triggering a report; determining, at the terminal device, whether an inference failure occurs in a data processing model; and transmitting the report to the network device, wherein the report at least indicates whether the inference failure occurs in the data processing model.

In a second aspect, there is provided a method for communication. The communication method comprises: transmitting, at a network device and to a terminal device, downlink information for triggering a report; and receiving the report from the terminal device, wherein the report at least indicates whether the inference failure occurs in the data processing model.

In a third aspect, there is provided a terminal device. The terminal device comprises a processing unit; and a memory coupled to the processing unit and storing instructions thereon, the instructions, when executed by the processing unit, causing the terminal device to perform acts comprising: receiving, from a network device, downlink information for triggering a report; determining, at the terminal device, whether an inference failure occurs in a data processing model; and transmitting the report to the network device, wherein the report at least indicates whether the inference failure occurs in the data processing model.

In a fourth aspect, there is provided a network device. The network device comprises a processing unit; and a memory coupled to the processing unit and storing instructions thereon, the instructions, when executed by the processing unit, causing the network device to perform acts comprising: transmitting, to a terminal device, downlink information for triggering an report; and receiving the report from the terminal device, wherein the report at least indicates whether the inference failure occurs in the data processing model.

In a fifth aspect, there is provided a computer readable medium having instructions stored thereon, the instructions, when executed on at least one processor, causing the at least one processor to carry out the method according to the first or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIGS. 3A-3E illustrate schematic diagrams of an AI/ML based beam management according to some embodiments of the present disclosure, respectively;

FIGS. 4A and 4B illustrate schematic diagrams of an AI/ML based channel state information (CSI) feedback according to some embodiments of the present disclosure, respectively;

FIG. 5 illustrates a schematic diagrams of an AI/ML based demodulation reference signal (DMRS) according to some embodiments of the present disclosure;

FIG. 6 illustrates a schematic diagrams of an AI/ML based demodulation CSI-RS according to some embodiments of the present disclosure;

FIG. 7 is a flowchart of an example method in accordance with an embodiment of the present disclosure;

FIG. 8 is a flowchart of an example method in accordance with an embodiment of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHZ), FR2 (24.25 GHz to 71 GHZ), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, the AI/ML model can be applied to different scenarios to achieve better performances. In some embodiments, the AI/ML model can be implemented at the network device side. Alternatively, the AI/ML model can be implemented at the terminal device side. In other embodiments, the AI/ML model can be implemented at both the network device and the terminal device.

For example, the terminal devices can perform the beam management on the AI/ML model. In this case, the terminal device can measure a part of candidate beam pairs and use AI or ML to estimate qualities for all candidate beam pairs. Massive MIMO (mMIMO) and beamforming are widely used in the telecom industry. Terms “beamforming” and “mMIMO” are sometimes used interchangeably. In general, beamforming uses multiple antennas to control the direction of a wave-front by appropriately weighting the magnitude and phase of individual antenna signals in an array of multiple antennas. The most commonly seen definition is that mMIMO is a system where the number of antennas exceeds the number of users. The coverage is beam-based in 5G, not cell based. There is no cell-level reference channel from where the coverage of the cell could be measured. Instead, each cell has one or multiple Synchronization Signal Block Beam (SSB) beams. SSB beams are static, or semi-static, always pointing to the same direction. They form a grid of beams covering the whole cell area. The user equipment (UE) searches for and measure the beams, maintaining a set of candidate beams. The candidate set of beams may contain beams from multiple cells. With 5G millimeter wave (mmWave) enabling directional communication with a larger number of antenna elements and providing an additional beamforming gain, efficient management of beams—where UE and gNB regularly identify the optimal beams to work on at any given point of time—has become crucial.

Additionally, the terminal device can perform CSI feedback based on the AI/ML model. In this situation, the original CSI information can be compressed by an AI encoder located in the terminal device, and recovered by an AI decoder located in the network device. The AI/ML model can also be sued for reference signal (RS) overhead reduction. For example, the terminal device can use a new RS pattern, such as, lower density DMRS, less CSI-RS port.

However, an inference failure can occur in the AI/ML model. The term “inference failure” used herein can refer to a situation where the AI/ML model cannot run successfully to obtain an inference result. Therefore, it is import to inform the network device the inference failure.

According to embodiments, solutions on improving the AI/ML model are proposed. According to embodiments of the present disclosure, a terminal device receives downlink information for triggering an report from a network device. The terminal device determines whether an inference failure occurs in a data processing model. The terminal device transmits the report to the network device. The report indicates whether the inference failure occurs in the data processing model and/or whether information in the report is generated based on the data processing model. In this way, the network device can be informed about the inference failure, thereby improving accuracy of information transmitted by the terminal device.

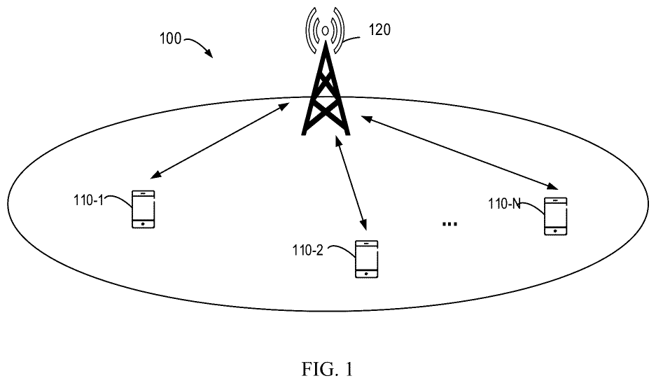

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number. The terminal devices 110 can communicate with each other.

The communication system 100 further comprises a network device. In the communication system 100, the network device 120 and the terminal devices 110 can communicate data and control information to each other. The numbers of terminal devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHZ, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

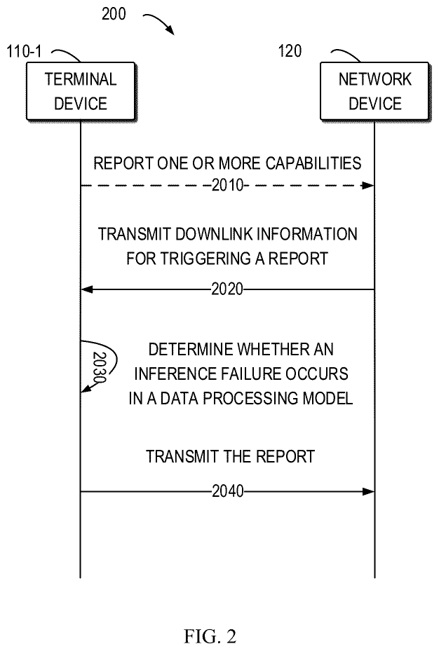

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1 and the network device 120 in FIG. 1. In some embodiments, the process 200 can be applied in the AI/ML-based beam management. Alternatively, the process 200 can be applied in the AI/ML-based CSI feedback. In other embodiments, the process 200 can be applied in the AI/ML-based DMRS. In some embodiments, the process 200 can be applied in the AI/ML-based CSI-RS.

In some embodiments, the terminal device 110-1 may report 2010 one or more capabilities of the terminal device 110-1 to the network device 120. The one or more capabilities at least indicate that the terminal device 110-1 supports a data processing model. The data processing model can be an AI/ML model. The term “AI/ML model” used herein can refer to a program or algorithm that utilizes a set of data that enables it to recognize certain patterns. This allows it to reach a conclusion or make a prediction when provided with sufficient information. Generally, the AI/ML model can be a mathematical algorithm that is “trained” using data and human expert input to replicate a decision an expert would make when provided that same information.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting CSI feedback based on AI/ML. Additionally, the capabilities may indicate that the terminal device 110-1 supports a capability of supporting DMRS based on AI/ML. In some other embodiments, the capabilities may indicate that the terminal device 110-1 supports a capability of supporting CSI-RS based on AI/ML.

The network device 120 transmits 2020 downlink information for triggering an report. In some embodiments, the report can be a periodic CSI report which can be configured by RRC signaling. Alternatively, the report can be a semi-persistent CSI report. In this case, such CSI report can be activated by a medium access control control element (MAC CE) from the network device 120. In other embodiments, the report can be an aperiodic CSI report or a SP-CSI report. In this case, the CSI report can be triggered by downlink control information (DCI) from the network device 120. In some embodiments, the downlink information may indicate that the report comprises an inference failure indicator (IFI). In some embodiments, the downlink information may indicate a first time offset which is associated with the transmission of the report. Alternatively or in addition, the downlink information may indicate a second time offset which is associated with the transmission of the report. In other embodiments, the second time offset can be transmitted in other downlink information. The second time offset is larger than the first time offset.

In some embodiments, the network device 120 may transmit a configuration of the report. For example, the configuration of the report can be transmitted via the higher layer configuration of CSI-ReportConfig. The configuration of the report may indicate that the CSI report is associated with one or more CSI-RS or SSB resource sets. In some embodiments, the CSI-RS resource set can be periodic. Alternatively, the CSI-RS resource set can be semi-persistent. In other embodiments, the CSI-RS resource set can be aperiodic. In some embodiments, each CSI-RS resource in the CSI-RS resource set can correspond to a beam.

The terminal device 110-1 determines 2030 whether an inference failure occurs in the data processing model. For example, when the terminal device 110-1 performs a normal AI/ML-based inference, the terminal device 110-1 can determine whether the process of AI/ML mode is interrupted. The process of AI/ML mode may be interrupted due to one of: memory overflow, CPU overload/overheat or timeout. If the process of AI/ML mode is interrupted, the terminal device 110-1 can determine that the inference failure occurs in the data processing model.

The terminal device 110-1 transmits 2040 the report to the network device 120. The report at least indicates whether the inference failure occurs in the data processing model. For example, if the report comprises CSI information and the report further indicates that the inference failure occurs in the data processing model, it means that the CSI information is not obtained based on the data processing model. Alternatively, if the report comprises CSI information and the report further indicates that the inference failure does not occur in the data processing model, it means that the CSI information is obtained based on the data processing model. In some embodiments, if the inference failure occurs, a CSI field in the report can be a set to a predefined bit value. For example, the predefined bit value can be all 0. Alternatively, the predefined bit value can be all 1. In this way, the network device 120 is able to know whether the inference failure occurs. Alternatively, a portion of the CSI field can be set to the predefined value. For example, bits in the reference signal received power (RSRP) can be set to the predefined value and bits in the CSI-RS resource indicator (CRI) field do not need to be set to the predefined value. In this way, the network device can know the inference failure occurs and the optimal beams.

In some embodiments, as mentioned above, the downlink information may indicate that the report comprises the IFI. In this case, the report can comprise the IFF and CSI responding to the IFI. In some embodiments, the report can comprise a single part to indicate the IFI and the CSI. Alternatively, the report can comprise a first part and a second part. In this situation, the first part can comprise the inference failure indicator and the second part can comprise the CSI corresponding to the inference failure indicator. In some other embodiments, the first part can comprise at least one of: the IFI, a rank indication (RI), a CSI-reference signal (CSI-RS) resource indicator (CRI), a channel quality indicator (CQI), or an indication of the number of non-zero wideband amplitude coefficients per layer for a Type2 CSI, and the second part can comprise a precoding matrix indicator (PMI). Alternatively, the report can comprise a first part, a second part and a third part. In this case, the first part can comprise the IFI, the second part can comprise at least one of: the RI, the CRI, the CQI, or the indication, and the third part can comprise the PMI.

In some other embodiments, as mentioned above, the terminal device 110-1 can be configured with the first time offset and the second time offset. In this case, if the inference failure does not occur in the data processing model, the terminal device 110-1 can transmit the report to the network device 120 according to the first time offset. In this case, the report can indicate a set of beams based on the data processing model and the second time offset can be ignored by the terminal device 110-1. Alternatively, if the inference failure occurs in the data processing model, the terminal device 110-1 can transmit the report to the network device 120 according to the second time offset. In this case, the report can indicate a set of beams which is not based on the data processing model and the first time offset can be ignored by the terminal device 110-1. In some other embodiments, if the inference failure occurs in the data processing model, the terminal device 110-1 can transmit the IFI according to the first time offset and then transmit the report to the network device 120. In this case, the report can indicate a set of beams which is not based on the data processing model. In this way, the network device 120 can know the inference failure and the actual optimal beam information as soon as possible.

In some embodiments, the terminal device 110-1 may be configured with an enable parameter. The enable parameter can enable the data processing model-based CSI feedback. The terminal device 110-1 may receive a configuration indicating a type of a codebook. In this case, if the inference failure occurs in the data processing model, the terminal device 110-1 can transmit the report based on the codebook.

Alternatively, the terminal device 110-1 can determine the type of the codebook. In this case, the report can comprise a bit field for indicating the type of the codebook.

In some embodiments, if the inference failure occurs in the data processing model, the report can comprise a non-acknowledgment (NACK) for all hybrid automatic repeat request-acknowledgment (HARQ-ACK) information bits. In other words, the report can refer to HARQ information. Alternatively, if the inference failure occurs in the data processing model, the report can comprise HARQ-ACK information bits and an uplink channel on which the report is transmitted can comprise an IFI field. In some embodiments, the uplink channel can be a physical uplink control channel.

In other embodiments, if the inference failure occurs in the data processing model, the terminal device 110-1 can scramble the uplink channel with an AI or ML specific scrambling sequence associated with the inference failure. In this case, the report can be transmitted in the uplink channel. In some embodiments, the uplink channel can refer to a PUCCH. Alternatively, the uplink channel can refer to a PUSCH. In other words, the terminal device 110-1 can use the AI/ML-specific scrambling sequence to scramble the PUSCH/PUCCH carrying CSI or HRRQ information. The scrambled PUSCH/PUCCH can be used to indicate that the inference failure occurs in the terminal device 110-1.

In some embodiments, the scrambling sequence can be generated based on a radio network temporary identity (RNTI) for AL or ML. For example, a new RNTI for AI/ML can be introduces, such as, AI-RNTI. Specifically, when scrambling PUCCH or PUSCH carrying CSI or HRRQ information, the terminal device 110-1 may firstly calculate a scrambling sequence cᵢₙᵢₜ according to a value of the RNTI. If the inference failure occurs, the terminal device 110-1 may calculate the scrambling sequence cᵢₙᵢₜ according to the value of the RNTI for AI/ML, e.g., AI-RNTI.

Alternatively, the scrambling sequence can be an AI/ML specific pseudo-random sequence. For example, the terminal device 110-1 can use a new DMRS sequence corresponding to the PUSCH/PUCCH carrying CSI or HRRQ information to indicate inference failure. Specifically, the new DMRS sequence can be AI/ML-specific, and it may have AI/ML specific pseudo-random sequence Cᵢₙᵢₜ. Further, the cᵢₙᵢₜ may have AI/ML specified scrambling ID (e.g., N_{ID}⁰ or N_{ID}¹, configured by high layer configuration of scramblingID0 or scramblingID0).

In other embodiments, the scrambling sequence can be an AI/ML specific mask. For example, if the inference failure occurs in the data processing model, the terminal device 110-1 can attach a cyclic redundancy check (CRC) with mask (e.g., AI/ML-specific mask) to transport block (i.e., raw data or CSI in PUSCH).

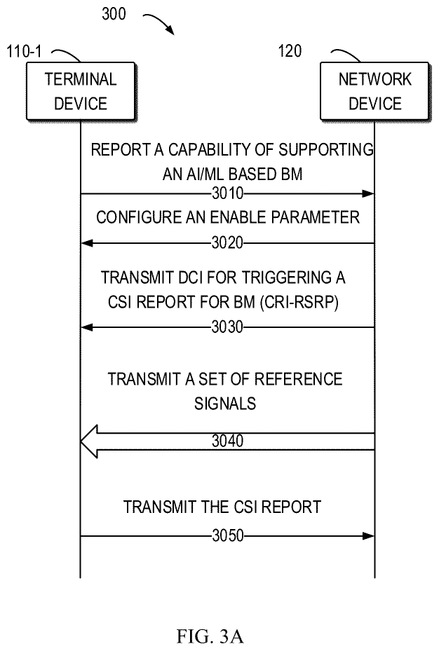

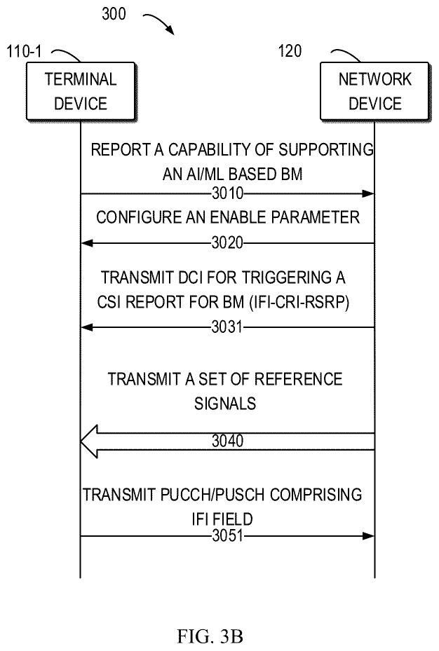

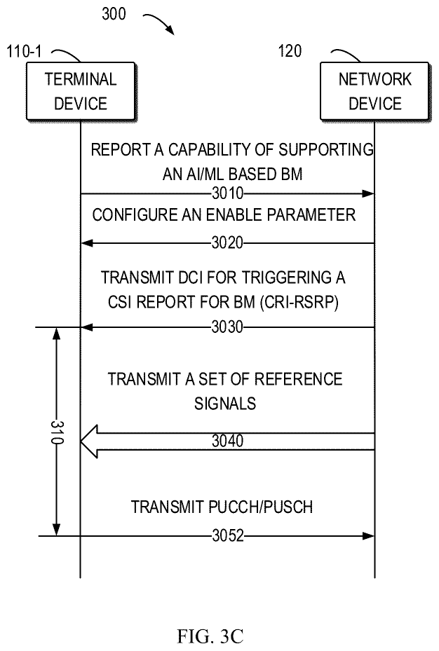

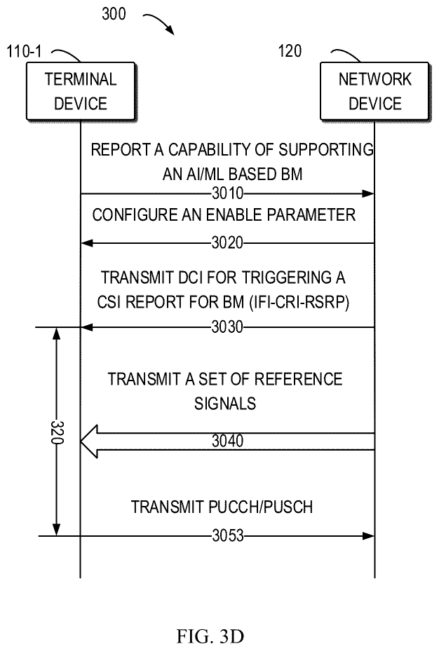

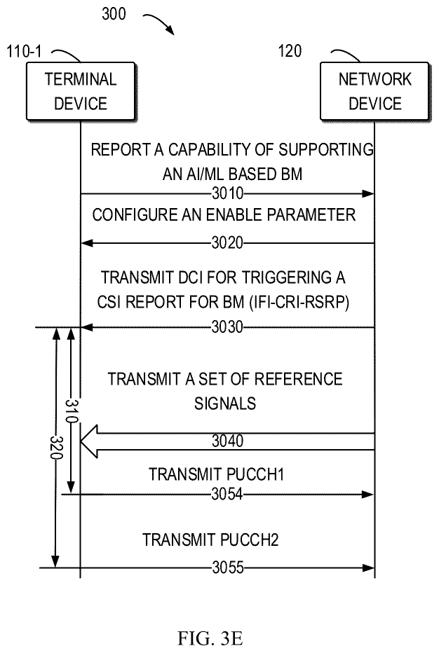

Example embodiments are described with reference to FIGS. 3A-6 in details. It should be noted that example embodiments described below can be implemented separately or together.

FIGS. 3A-3E show the process 300 of the AI/ML-based beam management, respectively.

The terminal device 110-1 may report 3010 a capability of supporting AI/ML-based BM. After that, the network device 120 may configure 3020 an enable parameter to enable the function of AI-ML based BM by a RRC signaling. The network device 120 can transmit 3030 DCI for triggering a CSI report for BM. The report quantity associated with the CSI report can be set to “CRI-RSRP” (or other quantities, e.g., synchronization signal/physical broadcast channel (SS/PBCH) Resource Block Indicator (SSBRI)-RSRP). The CSI-RS report can be associated with a CSI resource set including N CSI-RS resource, and each CSI-RS resource can correspond to a beam (direction). The network device 120 can transmit 3040 the set of reference signals to the terminal device 110-1.

The terminal device 110-1 can estimate beam qualities (e.g., L1-RSRP) of all N candidate beams according to M (M<N, M=N/a, a∈[1,N]) beams out of N candidate beams by using an AI prediction. Then, the terminal device 110-1 can determine the K optimal beams (i.e., having the largest L1-RSRP), and report the K (configured by the existing high layer configuration nrofReportedRS, e.g., K=1, 2 or 4) optimal beams to the network device 120 after a configured time offset (configured by a high layer configuration of reportSlotOffset). Specifically, K CRIs and L1-RSRPs corresponding to the K optimal beams can be reported.

The terminal device 110-1 can transmit 3050 the CSI report to the network device 120. If the inference failure occurs in the data processing model, all beam qualities of the N candidate beams cannot be estimated. In this case, a predefined bit value (or state) as an indicator in CSI field can be introduced. The indicator can be used to indicate that the inference failure occurs in the terminal device 110-1. For example, the entire CSI field including all CRI field and all RSRP field in the CSI report can be set to all “0” or all “1”.In this way, the network device can know whether the inference failure occurs. Alternatively, partial CSI field in the CSI report can be set to all “0” or all “1”. For example, only all of the RSRP fields in the CSI report can be set to all “0” or all “1”. Further, K CRIs corresponding to K optimal beams out of the M candidate beams can be indicated in the CRI field. In this way, if the inference failure occurs, the network device can know both the occurrence of the inference failure and the (IDs of) K optimal beams (determined from the M candidate beams).

In some embodiments, a new bit field as an inference failure indicator (IFI) can be introduced. Specifically, the new bit field can be introduced in CSI field. Further, the IFI field can comprise 1 bit and it refers to whether inference failure has occurred. In other words, it means that whether corresponding CSI (e.g., CRI-RSRP, SSBRI-RSRP, CRI-signal to interference plus noise ratio (SINR), SSBRI-SINR) can be acquired based on AI prediction (i.e., the data processing model). The term “corresponding CSI” can refer to the CSI on PUCCH/PUSCH resource where the IFI is located or the CSI in the same report as IFI.

In some embodiments, the IFI can be introduced into CSI report as a report quantity. Referring to FIG. 3B, the network device 120 can transmit 3031 DCI for triggering a CSI report for BM. The report quantity (configured with high layer configuration of reportQuantity) associated with CSI report can be set to “IFI-CRI-RSRP”. The IFI can occupy 1 bit field. In this case, the terminal device 110-1 can transmit 3051 PUCCH/PUSCH comprising the IFI field to the network device 120. If the inference failure occurs, the terminal device 110-1 may report “0” in the IFI field, which also means that the CRI(s) and L1-RSRP(s) corresponding to the IFI are not based on the AI prediction (i.e., the data processing model). If the inference failure does not occur, the terminal device 110-1 may report “1” in the IFI field, which also means that CRI(s) and L1-RSRP(s) corresponding to the IFI are based on AI prediction (i.e., the data processing model). In other embodiments, the IFI can also comprise more than 1 bit. In this case, the terminal device can also report an index of the data processing model with the inference failure to the network device.

In some embodiments, IFI and CRI-RSRP may be included in the same part. Alternatively, IFI and CRI-RSRP may not be included in the same part. For example, if the report quantity is set to “IFI-CRI-RSRP”, the CSI report can comprise a single part. Alternatively, the CSI report can comprise two parts: a first part and a second part. In this case, the first part can comprise the IFI and the second part can comprise CRI-RSRP. The first part and second part refer to Part 1 and Part 2, respectively, i.e., part 1 and part 2 in Type1 or Type 2 CSI feedback. In this way, the network device can know that whether the inference failure occurs and whether the reported K optimal beams are based on AI prediction.

In some other embodiments, one CSI report can be associated with two time offsets, which are used for AI-based beam reporting and legacy (or default, alternative) beam reporting, respectively. Specifically, the terminal device 110-1 can receive DCI scheduled a CSI report for BM. The DCI can indicate 2 time offsets (for example, t1 and t2) simultaneously, i.e., the CSI report is associated with two time offsets: t1 and t2. The value of t1 can be configured according to the required time for measuring M candidate beams and delay of AI process (relatively small). The value of t2 can be configured according to the required time for measuring all N candidate beams. Therefore, the value of t2 is larger than that of t1. In some embodiments, the two time offsets can be indicated by two separate fields in DCI. And they are selected from the same time offset list (e.g., reportSlotOffsetList) or two separate time offset lists (e.g., reportSlotOffsetList and reportSlotOffsetListForAI) configured by RRC. Alternatively, one time offset can be indicated by DCI, the other time offset can be associated with the time offset or the time offset list including the time offset. For example, the other time offset can be configured in a CSI trigger state (e.g., CSI-AperiodicTriggerState) or a CSI report (CSI-ReportConfig).

Referring to FIGS. 3C-3E, the terminal device 110-1 can be configured with the time slot 310 and the time slot 320. It is assumed that the scheduling DCI can be located in slot n. As shown in FIG. 3C, if the inference failure does not occur, the terminal device 110-1 can transmit 3052 the AI-based beam report in PUSCH in slot n+K2. K2 can refer to the slot interval between the PUSCH carrying the CSI and the scheduling DCI. In this case, the value of K2 can be determined according to the smallest time offset 310 (and other indicated time offsets, if exists, e.g., time offsets associated with other CSI reports, time offset in TDRA field in the scheduling DCI) and the largest time offset 320 can be ignored. In this way, the network device can know that the inference failure does not occur in the terminal device 110-1 and K optimal beams based on AI prediction. Alternatively, as shown in FIG. 3D, if the inference failure occurs, the terminal device 110-1 can transmit 3053 the legacy beam report in PUSCH in slot n+K2. In this case, the value of K2 can be determined according to the largest time offset 320 (and other indicated time offsets, if exists) and the smallest time offset 310 can be ignored. In this way, the network device can knows that the inference failure occurs in the terminal device and optimal beams based on legacy beam measurement, i.e., measure all N candidate beams.

Alternatively, the content of AI-based beam report at t1 can comprise at least IFI information (for example, the predefined bit value in the CRI-RSRP field or RSRP field), and the content of legacy beam report in t2 may comprise beam information (e.g., CRI-RSRP). Referring to FIG. 3E, the terminal device 110-1 may transmit 3054 the PUCCH 1 which comprises at least IFI information to the network device 120. The terminal device 110-1 may then transmit 3055 the PUCCH 2 which comprise the beam information to the network device 120. In this way, if the inference failure occurs, the network device can not only know the inference failure in time, but also know actual optimal beam information as soon as possible, because the terminal device does not need to wait for another CSI report to be triggered by the network device again.

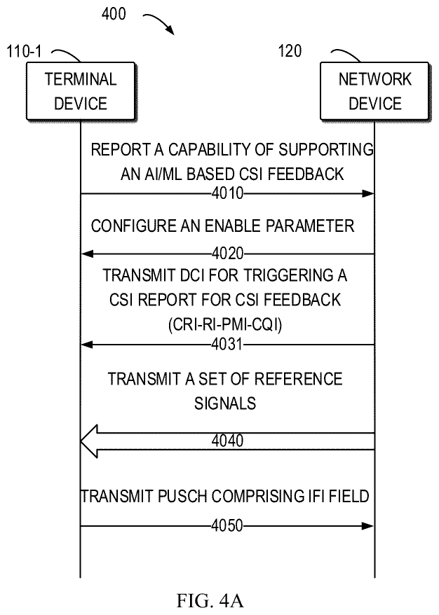

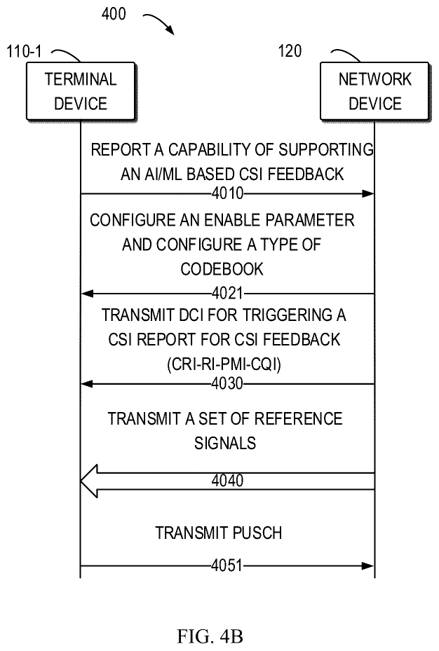

FIGS. 4A-4B show the process 400 of the AI/ML-based CSI feedback, respectively. The terminal device 110-1 may report 4010 a capability of supporting AI/ML-based CSI feedback. After that, the network device 120 may configure 4020 an enable parameter to enable the function of AI-ML based CSI feedback by a RRC signaling (i.e., high layer configuration). The network device 120 can transmit 4030 DCI for triggering a CSI report for CSI acquisition. The report quantity (i.e., report content) associated with the CSI report can be set to “CRI-RI-PMI-CQI” (or other quantities, e.g., compressed CSI). The CSI-RS report can be associated with a CSI resource set including N CSI-RS resource, and each CSI-RS resource can correspond to a beam (direction).

The network device 120 can transmit 4040 the set of reference signals to the terminal device 110-1. The terminal device 110-1 can calculate a compressed CSI (i.e., a bit stream) according to the CSI-RS resource associated with the CSI report by using an AI encoder. After a configured time offset (configured by a high layer configuration of reportSlotOffset), the terminal device 110-1 can transmit the compressed bit stream in CSI field in PUSCH to the network device 120.

In some embodiments, a new bit field as an IFI can be introduced. Specifically, the new bit field can be introduced in CSI field. Further, the IFI field can comprise 1 bit and it refers to whether inference failure has occurred. In other words, it means that whether corresponding CSI (e.g., CRI, rank indication (RI), precoding matrix indicator (PMI), channel quality indicator (CQI), compressed CSI) is acquired based on AI prediction. The term “corresponding CSI” can refer to the CSI on PUCCH/PUSCH resource where the IFI is located or the CSI in the same report as IFI. In this case, referring to FIG. 4A, the terminal device 110-1 may transmit 4050 PUCCH comprising the IFI to the network device 120. If the inference failure occurs, the terminal device 110-1 may report “0” in the IFI field, which also means that CRI, RI, CQI and (or) PMI corresponding to the IFI are not based on the AI encoder. If the inference failure does not occur, the terminal device 110-1 may report “1” in the IFI field, which also means that CRI, RI, CQI and (or) PMI corresponding to the IFI are based on AI encoder. In other embodiments, the IFI can also comprise more than 1 bit. In this case, the terminal device can also report an index of the data processing model with the inference failure to the network device.

In some embodiments, IFI and CRI-RI-PMI-CQI may be included in the same part. Alternatively, IFI and CRI-RI-PMI-CQI may not be included in the same part. Specifically, for Type1, Type2 and Enhanced Type2 CSI feedback can be on PUCCH/PUSCH. In some embodiments, the CSI report can comprise two parts: part 1 and part 2. In this case, the part 1 can comprise at least one of IFI, RI, CRI, CQI and an indication of the number of non-zero wideband amplitude coefficients per layer for the Type2 CSI. The part 2 can comprise PMI. Alternatively, the CSI report can comprise three parts: first part, second part and third part. In this case, the first part can comprise IFI. The second part and the third part refer to part 1 and part 2, respectively. In this way, the network device can know that whether the inference failure occurs and whether the reported CSI is based on AI encoder.

In some other embodiments, if the terminal device 110-1 is provided with the enable parameter enabling AI/ML-based CSI feedback, the terminal device 110-1 does expected to be configured with a type of codebook. Referring to FIG. 4B, when the terminal device 110-1 is configured with the enable parameter enabling AI/ML-based CSI feedback, the network device 120 may also configure 4021 the type of the codebook. For example, the network device 120 may transmit the configuration of the codebook (for example, via a higher layer configuration). In this case, if the inference failure occurs, the terminal device 110-1 may transmit 4051 the PUSCH based on the configured codebook. Alternatively, the terminal device 110-1 can select the type of codebook. In this case, a new bit field can be introduced to indicate the selected codebook to the network device 120. For example, part 1 in the PUSCH may comprise a new bit field for indicating the type of codebook (in part 2). In this way, in addition to the occurrence of inference failure and the AI encoder-based reported PUSCH, the network device also knows which codebook the terminal device calculates the reported PUSCH based on.

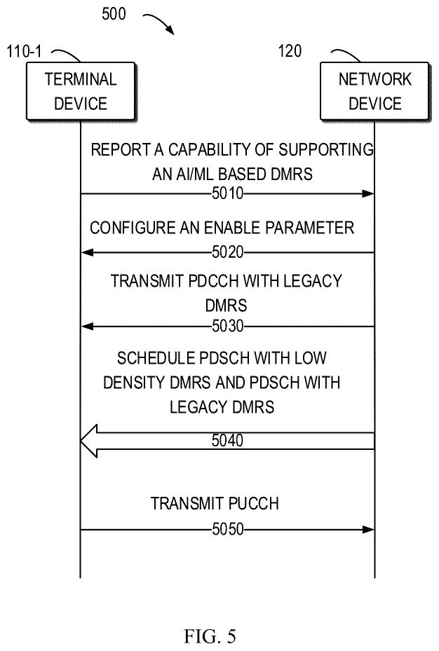

FIG. 5 shows the process 500 of the AI/ML-based DMRS. The terminal device 110-1 may report 5010 a capability of supporting AI/ML-based DMRS. After that, the network device 120 may configure 5020 an enable parameter to enable the function of AI-ML based DMRS by a RRC signaling. The network device 120 may transmit 5030 a PDCCH with a low density DMRS. The DMRS can be used to demodulate PDCCH. Specifically, the terminal device 110-1 can use the channel response on DMRS resources to estimate channel on all resources by using AI DMRS. Then, the network device 120 can schedule 5040 a PDSCH with a low density DMRS. According to the same AI DMRS, the terminal device 110-1 may also demodulate scheduled PDSCH. Finally, the terminal device 110-1 may decide whether to report HARQ-ACK or HARQ-NACK according to whether the received PDSCH is correct or not (e.g., by using CRC check).

If the inference failure occurs, the terminal device 110-1 can inform the network device 120 the occurrence of the inference failure in an implicit manner. For example, if the inference failure occurs, the terminal device 110-1 may generate a NACK for all HARQ-ACK information bits in PUCCH, regardless of whether other PDSCH(s) decoded correctly. The terminal device 110-1 can transmit 5050 the PUCCH comprising the NACK to the network device 120. In this way, when receiving a PUCCH in which all HARQ information bits are NACK, the network device can knows that the inference failure occurs in the terminal device. Alternatively, the terminal device 110-1 can inform the network device 120 the occurrence of the inference failure in an explicit manner. For example, a new bit field can be introduced as an IFI in PUCCH. Specifically, the IFI field can comprise 1 bit and it refers to whether inference failure has occurred. In this case, the terminal device 110-1 can transmit 5050 the PUCCH comprising the IFI field to the network device 120. The HARQ-ACK information bits in the PUCCH can indicate whether the corresponding PDSCH is decoded correctly or not. In this way, the network device can know whether the inference failure occurs and the HARQ feedback of other PDSCHs cannot be affected.

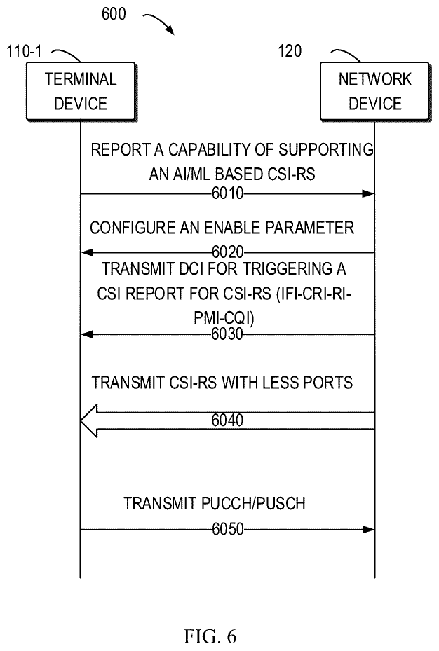

FIG. 6 shows the process of the AI/ML based CSI-RS. The terminal device 110-1 can report 6010 a capability of supporting AI/ML-based CSI-RS. After that, the network device 120 may configure 6020 an enable parameter to enable the function of AI-ML based CSI-RS by a RRC signaling. It is assumed that the network device 120 wants to know DL CSI corresponding to 32 antenna ports. The network device 120 can transmit 6030 DCI for triggering a CSI report for CSI-RS. The network device 120 may transmit 6040 a CSI-RS with 16 ports. After receive the CSI-RS, the terminal device can estimate the channel on resource corresponding to CSI-RS with 32 ports based on channel on resource corresponding to CSI-RS with 16 ports by using AI CSI-RS. Then, the terminal device can report the CSI corresponding to the 32 antenna ports to the network device 120 after a configured time offset.

In some embodiments, a new bit field as an inference failure indicator (IFI) can be introduced. Specifically, the new bit field can be introduced in CSI field. Further, the IFI field can comprise 1 bit and it refers to whether inference failure has occurred. In other words, it means that whether corresponding CSI (e.g., CRI, LI, RI, PMI, CQI, i1) is acquired based on AI CSI-RS. The term “corresponding CSI” can refer to the CSI on PUCCH/PUSCH resource where the IFI is located or the CSI in the same report as IFI.

In some embodiments, the IFI can be introduced into CSI as a report quantity. The report quantity (configured with high layer configuration of reportQuantity) associated with CSI report can be set to “IFI-CRI-RI-PMI-CQI”. The IFI can occupy 1 bit field. In this case, the terminal device 110-1 can transmit 6050 PUCCH/PUSCH comprising the IFI field to the network device 120. If the inference failure occurs, the terminal device 110-1 may report “0” in the IFI field, which also means that CRI, RI, CQI and PMI corresponding to the IFI are not based on AI CSI-RS, that is, the reported CRI, RI, CQI and PMI are determined according to the CSI-RS 16 ports. If the inference failure does not occur, the terminal device 110-1 may report “1” in the IFI field, which also means that CRI, RI, CQI and PMI corresponding to the IFI are based on AI encoder, that is, the reported CRI, RI, CQI and PMI are determined according to the CSI-RS 32 ports. In other embodiments, the IFI can also comprise more than 1 bit. In this case, the terminal device 110-1 can also report an index of the data processing model with the inference failure to the network device 120. In this way, the network device can know that whether the inference failure occurs and whether the reported CSI is based on AI encoder.

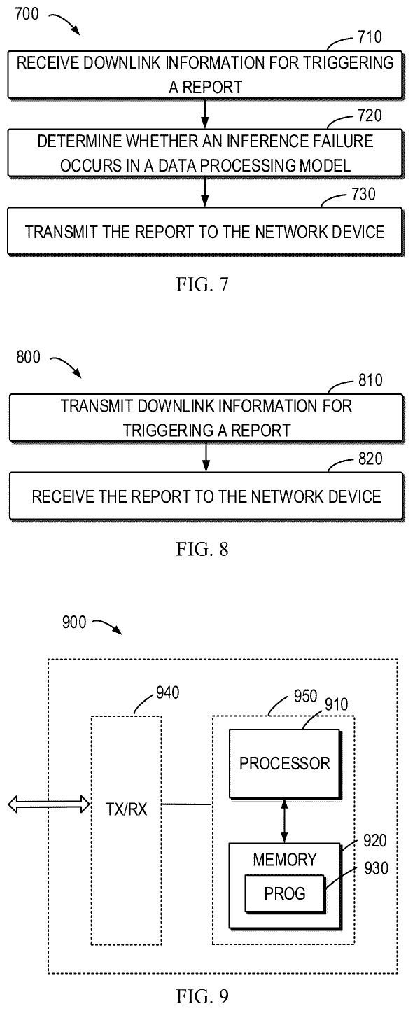

FIG. 7 shows a flowchart of an example method 700 in accordance with an embodiment of the present disclosure. The method 700 can be implemented at any suitable devices. Only for the purpose of illustrations, the method 700 can be implemented at a terminal device 110-1 as shown in FIG. 1.

In some embodiments, the terminal device 110-1 may report one or more capabilities of the terminal device 110-1 to the network device 120. The one or more capabilities at least indicate that the terminal device 110-1 supports a data processing model. The data processing model can be an AI/ML model. The term “AI/ML model” used herein can refer to a program or algorithm that utilizes a set of data that enables it to recognize certain patterns. This allows it to reach a conclusion or make a prediction when provided with sufficient information. Generally, the AI/ML model can be a mathematical algorithm that is “trained” using data and human expert input to replicate a decision an expert would make when provided that same information.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting CSI feedback based on AI/ML. Additionally, the capabilities may indicate that the terminal device 110-1 supports a capability of supporting DMRS based on AI/ML. In some other embodiments, the capabilities may indicate that the terminal device 110-1 supports a capability of supporting CSI-RS based on AI/ML.

At block 710, the terminal device 110-1 receives downlink information for triggering a report from the network device 120. In some embodiments, the report can be a periodic CSI report which can be configured by RRC signaling. Alternatively, the report can be a semi-persistent CSI report. In this case, such CSI report can be activated by a MAC CE from the network device 120. In other embodiments, the report can be an aperiodic CSI report or a SP-CSI report. In this case, the CSI report can be triggered by DCI from the network device 120. In some embodiments, the downlink information may indicate that the report comprises an IFI. In some embodiments, the downlink information may indicate a first time offset which is associated with the transmission of the report. Alternatively or in addition, the downlink information may indicate a second time offset which is associated with the transmission of the report. In other embodiments, the second time offset can be transmitted in other downlink information. The second time offset is larger than the first time offset.

In some embodiments, the terminal device 110-1 may receive a configuration of the report. For example, the configuration of the report can be transmitted via the higher layer configuration of CSI-ReportConfig. The configuration of the report may indicate that the CSI report is associated with one or more CSI-RS or SSB resource sets. In some embodiments, the CSI-RS resource set can be periodic. Alternatively, the CSI-RS resource set can be semi-persistent. In other embodiments, the CSI-RS resource set can be aperiodic. In some embodiments, each CSI-RS resource in the CSI-RS resource set can correspond to a beam.

At block 720, the terminal device 110-1 determines whether an inference failure occurs in the data processing model. For example, when the terminal device 110-1 performs a normal AI/ML-based inference, the terminal device 110-1 can determine whether the process of AI/ML mode is interrupted. The process of AI/ML mode may be interrupted due to one of: memory overflow, CPU overload/overheat or timeout. If the process of AI/ML mode is interrupted, the terminal device 110-1 can determine that the inference failure occurs in the data processing model.

At block 730, the terminal device 110-1 transmits the report to the network device 120. The report at least indicates whether the inference failure occurs in the data processing model. For example, if the report comprises CSI information and the report further indicates that the inference failure occurs in the data processing model, it means that the CSI information is not obtained based on the data processing model. Alternatively, if the report comprises CSI information and the report further indicates that the inference failure does not occur in the data processing model, it means that the CSI information is obtained based on the data processing model. In some embodiments, if the inference failure occurs, a CSI field in the report can be a set to a predefined bit value. For example, the predefined bit value can be all 0. Alternatively, the predefined bit value can be all 1. In this way, the network device 120 is able to know whether the inference failure occurs. Alternatively, a portion of the CSI field can be set to the predefined value. For example, bits in the RSRP can be set to the predefined value and bits in the CRI field do not need to be set to the predefined value. In this way, the network device can know the inference failure occurs and the optimal beams.

In some embodiments, as mentioned above, the downlink information may indicate that the report comprises the IFI. In this case, the report can comprise the IFF and CSI responding to the IFI. In some embodiments, the report can comprise a single part to indicate the IFI and the CSI. Alternatively, the report can comprise a first part and a second part. In this situation, the first part can comprise the inference failure indicator and the second part can comprise the CSI corresponding to the inference failure indicator. In some other embodiments, the first part can comprise at least one of: the IFI, a RI, a CSI-RS, a CRI, a CQI, or an indication of the number of non-zero wideband amplitude coefficients per layer for a Type2 CSI, and the second part can comprise a PMI. Alternatively, the report can comprise a first part, a second part and a third part. In this case, the first part can comprise the IFI, the second part can comprise at least one of: the RI, the CRI, the CQI, or the indication, and the third part can comprise the PMI.

In some other embodiments, as mentioned above, the terminal device 110-1 can be configured with the first time offset and the second time offset. In this case, if the inference failure does not occur in the data processing model, the terminal device 110-1 can transmit the report to the network device 120 according to the first time offset. The report can indicate a set of beams based on the data processing model and the second time offset can be ignored by the terminal device 110-1. Alternatively, if the inference failure occurs in the data processing model, the terminal device 110-1 can transmit the report to the network device 120 according to the second time offset. In this case, the report can indicate a set of beams which is not based on the data processing model and the first time offset can be ignored by the terminal device 110-1. In some other embodiments, if the inference failure occurs in the data processing model, the terminal device 110-1 can transmit the IFI according to the first time offset and then transmit the report to the network device 120. In this case, the report can indicate a set of beams which is not based on the data processing model. In this way, the network device 120 can know the inference failure and the actual optimal beam information as soon as possible.

In some embodiments, the terminal device 110-1 may be configured with an enable parameter. The enable parameter can enable the data processing model-based CSI feedback. The terminal device 110-1 may receive a configuration indicating a type of a codebook. In this case, if the inference failure occurs in the data processing model, the terminal device 110-1 can transmit the report based on the codebook.

Alternatively, the terminal device 110-1 can determine the type of the codebook. In this case, the report can comprise a bit field for indicating the type of the codebook.

In some embodiments, if the inference failure occurs in the data processing model, the report can comprise a NACK for all HARQ-ACK information bits. In other words, the report can refer to HARQ information. Alternatively, if the inference failure occurs in the data processing model, the report can comprise the IFI and HARQ-ACK information bits and an uplink channel on which the report is transmitted can comprise an IFI field. In some embodiments, the uplink channel can be a physical uplink control channel.

In other embodiments, if the inference failure occurs in the data processing model, the terminal device 110-1 can scramble the uplink channel with an AI or ML specific scrambling sequence associated with the inference failure. In this case, the report can be transmitted in the uplink channel. In some embodiments, the uplink channel can refer to a PUCCH. Alternatively, the uplink channel can refer to a PUSCH. In other words, the terminal device 110-1 can use the AI/ML-specific scrambling sequence to scramble the PUSCH/PUCCH carrying CSI or HRRQ information. The scrambled PUSCH/PUCCH can be used to indicate that the inference failure occurs in the terminal device 110-1.

In some embodiments, the scrambling sequence can be generated based on a RNTI for AL or ML. For example, a new RNTI for AI/ML can be introduces, such as, AI-RNTI. Specifically, when scrambling PUCCH or PUSCH carrying CSI or HRRQ information, the terminal device 110-1 may firstly calculate a scrambling sequence cᵢₙᵢₜ according to a value of the RNTI. If the inference failure occurs, the terminal device 110-1 may calculate the scrambling sequence cᵢₙᵢₜ according to the value of the RNTI for AI/ML, e.g., AI-RNTI.

Alternatively, the scrambling sequence can be an AI/ML specific pseudo-random sequence. For example, the terminal device 110-1 can use a new DMRS sequence corresponding to the PUSCH/PUCCH carrying CSI or HRRQ information to indicate inference failure. Specifically, the new DMRS sequence can be AI/ML-specific, and it may have AI/ML specific pseudo-random sequence cᵢₙᵢₜ. Further, the cᵢₙᵢₜ may have AI/ML specified scrambling ID (e.g., N_{ID}⁰ or N_{ID}¹, configured by high layer configuration of scramblingID0 or scramblingID0).

In other embodiments, the scrambling sequence can be an AI/ML specific mask. For example, if the inference failure occurs in the data processing model, the terminal device 110-1 can attach a CRC with mask (e.g., AI/ML-specific mask) to transport block (i.e., raw data or CSI in PUSCH).

FIG. 8 shows a flowchart of an example method 800 in accordance with an embodiment of the present disclosure. The method 800 can be implemented at any suitable devices. Only for the purpose of illustrations, the method 800 can be implemented at a network device 120 as shown in FIG. 1.

In some embodiments, the network device 120 may receive a report indicating one or more capabilities of the terminal device 110-1 from the terminal device 110-1. The one or more capabilities at least indicate that the terminal device 110-1 supports a data processing model. The data processing model can be an AI/ML model. The term “AI/ML model” used herein can refer to a program or algorithm that utilizes a set of data that enables it to recognize certain patterns. This allows it to reach a conclusion or make a prediction when provided with sufficient information. Generally, the AI/ML model can be a mathematical algorithm that is “trained” using data and human expert input to replicate a decision an expert would make when provided that same information.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting CSI feedback based on AI/ML. Additionally, the capabilities may indicate that the terminal device 110-1 supports a capability of supporting DMRS based on AI/ML. In some other embodiments, the capabilities may indicate that the terminal device 110-1 supports a capability of supporting CSI-RS based on AI/ML.

At block 810, the network device 120 transmits downlink information for triggering a report. In some embodiments, the report can be a periodic CSI report which can be configured by RRC signaling. Alternatively, the report can be a semi-persistent CSI report. In this case, such CSI report can be activated by a MAC CE from the network device 120. In other embodiments, the report can be an aperiodic CSI report or a SP-CSI report. In this case, the CSI report can be triggered by DCI from the network device 120. In some embodiments, the downlink information may indicate that the report comprises an IFI. In some embodiments, the downlink information may indicate a first time offset which is associated with the transmission of the report. Alternatively or in addition, the downlink information may indicate a second time offset which is associated with the transmission of the report. In other embodiments, the second time offset can be transmitted in other downlink information. The second time offset is larger than the first time offset.

In some embodiments, the network device 120 may transmit a configuration of the report. For example, the configuration of the report can be transmitted via the higher layer configuration of CSI-ReportConfig. The configuration of the report may indicate that the CSI report is associated with one or more CSI-RS or SSB resource sets. In some embodiments, the CSI-RS resource set can be periodic. Alternatively, the CSI-RS resource set can be semi-persistent. In other embodiments, the CSI-RS resource set can be aperiodic. In some embodiments, each CSI-RS resource in the CSI-RS resource set can correspond to a beam.

At block 820, the network device 120 receives the report from the terminal device 110-1. The report at least indicates whether the inference failure occurs in the data processing model. For example, if the report comprises CSI information and the report further indicates that the inference failure occurs in the data processing model, it means that the CSI information is not obtained based on the data processing model. Alternatively, if the report comprises CSI information and the report further indicates that the inference failure does not occur in the data processing model, it means that the CSI information is obtained based on the data processing model. In some embodiments, if the inference failure occurs, a CSI field in the report can be a set to a predefined bit value. For example, the predefined bit value can be all 0. Alternatively, the predefined bit value can be all 1. In this way, the network device 120 is able to know whether the inference failure occurs. Alternatively, a portion of the CSI field can be set to the predefined value. For example, bits in the RSRP can be set to the predefined value and bits in the CRI field do not need to be set to the predefined value. In this way, the network device can know the inference failure occurs and the optimal beams.

In some embodiments, as mentioned above, the downlink information may indicate that the report comprises the IFI. In this case, the report can comprise the IFF and CSI responding to the IFI. In some embodiments, the report can comprise a single part to indicate the IFI and the CSI. Alternatively, the report can comprise a first part and a second part. In this situation, the first part can comprise the inference failure indicator and the second part can comprise the CSI corresponding to the inference failure indicator. In some other embodiments, the first part can comprise at least one of: the IFI, a RI, a CRI, a CQI, or an indication of the number of non-zero wideband amplitude coefficients per layer for a Type2 CSI, and the second part can comprise a PMI. Alternatively, the report can comprise a first part, a second part and a third part. In this case, the first part can comprise the IFI, the second part can comprise at least one of: the RI, the CRI, the CQI, or the indication, and the third part can comprise the PMI.

In some other embodiments, as mentioned above, the terminal device 110-1 can be configured with the first time offset and the second time offset. In this case, if the inference failure does not occur in the data processing model, the network device 120 can receive the report according to the first time offset. The report can indicate a set of beams based on the data processing model. Alternatively, if the inference failure occurs in the data processing model, the network device 120 can receive the report according to the second time offset. In this case, the report can indicate a set of beams which is not based on the data processing model. In some other embodiments, if the inference failure occurs in the data processing model, the network device 120 can receive the IFI according to the first time offset and then receive the report. In this case, the report can indicate a set of beams which is not based on the data processing model. In this way, the network device 120 can know the inference failure and the actual optimal beam information as soon as possible.

In some embodiments, the terminal device 110-1 may be configured with an enable parameter. The enable parameter can enable the data processing model-based CSI feedback. The network device 110-1 may transmit a configuration indicating a type of a codebook. In this case, if the inference failure occurs in the data processing model, the terminal device 110-1 can transmit the report based on the codebook.

Alternatively, the terminal device 110-1 can determine the type of the codebook. In this case, the report can comprise a bit field for indicating the type of the codebook.

In some embodiments, if the inference failure occurs in the data processing model, the report can comprise a NACK for all HARQ-ACK information bits. Alternatively, if the inference failure occurs in the data processing model, the report can comprise the IFI and HARQ-ACK information bits.

In other embodiments, if the inference failure occurs in the data processing model, the uplink channel can be scrambled with an Al or ML specific scrambling sequence associated with the inference failure. In this case, the report can be transmitted in the uplink channel. In some embodiments, the uplink channel can refer to a PUCCH. Alternatively, the uplink channel can refer to a PUSCH. In other words, the terminal device 110-1 can use the AI/ML-specific scrambling sequence to scramble the PUSCH/PUCCH carrying CSI or HRRQ information. The scrambled PUSCH/PUCCH can be used to indicate that the inference failure occurs in the terminal device 110-1. In this case, the network device 120 can determine that the inference failure occurs in the terminal device 110-1 based on the scrambled PUSCH/PUCCH.

In some embodiments, a terminal device comprises circuitry configured to receive, from a network device, downlink information for triggering a report; and determine whether an inference failure occurs in a data processing model; and transmit the report to the network device, wherein the report at least indicates whether the inference failure occurs in the data processing model.

In some embodiments, the terminal device comprises circuitry configured to transmit the report to the network device by in accordance with a determination of an occurrence of the inference failure, transmitting the report to the network device, wherein a channel state information (CSI) field in the report is set to a predefined bit value, or a portion of the CSI field is set to the predefined bit value.

In some embodiments, the report comprises at least one of: an inference failure indicator, or a CSI corresponding to the inference failure indicator, and the inference failure indicator indicates whether the inference failure occurs in the data processing model.

In some embodiments, the downlink information indicates whether the report comprises the inference failure indicator or not.

In some embodiments, the report comprises a single part, wherein the single part comprises at least one of the inference failure indicator and the CSI corresponding to the inference failure indicator.

In some embodiments, the report comprises a first part and a second part, wherein the first part comprises the inference failure indicator and the second part comprises the CSI corresponding to the inference failure indicator.

In some embodiments, the report comprises a first part and a second part, wherein the first part comprises at least one of: the inference failure indicator, a rank indication (RI), a CSI-reference signal (CSI-RS) resource indicator (CRI), a channel quality indicator (CQI), or an indication of the number of non-zero wideband amplitude coefficients per layer for a Type2 CSI, and the second part comprises a precoding matrix indicator (PMI).

In some embodiments, the report comprises a first part, a second part and a third part, wherein the first part comprises the inference failure indicator, the second part comprises at least one of: the RI, the CRI, the CQI, or the indication, and the third part comprises the PMI.

In some embodiments, the terminal device comprises circuitry configured to in accordance with a determination that the terminal device is configured with an enable parameter which enables the data processing model-based CSI feedback, receive, from the network device, a configuration indicating a type of a codebook. In some embodiments, the terminal device comprises circuitry configured to transmit the report to the network device by: in accordance with a determination of an occurrence of the inference failure, transmitting the report comprising the CSI that is based on the codebook.

In some embodiments, the terminal device comprises circuitry configured to determine a type of a codebook. In some embodiments, the terminal device comprises circuitry configured to transmit the report to the network device by: transmitting the report to the network device, wherein the report comprises a bit field indicating the type of the codebook.

In some embodiments, the downlink information indicates a first time offset and a second time offset which is larger than the first time offset, or wherein the downlink information indicates the first time offset and further downlink information indicates the second time offset.

In some embodiments, the terminal device comprises circuitry configured to transmit the report to the network device by: in accordance with a determination that the inference failure does not occur in the data processing model, transmitting the report to the network device according to the first time offset, wherein the report indicates a set of beams based on the data processing model and the second time offset is omitted.

In some embodiments, the terminal device comprises circuitry configured to transmit the report to the network device by: in accordance with a determination of an occurrence of the inference failure, transmitting the report to the network device according to the second time offset, wherein the report indicates a set of beams which is not based on the data processing model and the first time offset is omitted.

In some embodiments, the terminal device comprises circuitry configured to transmit the report to the network device by: in accordance with a determination of an occurrence of the inference failure, transmitting a channel state information (CSI) field in the report is set to a predefined bit value, or a portion of the CSI field is set to the predefined bit value or an inference failure indicator according to the first time offset; and transmitting the report to the network device according to the second time offset, wherein the report indicates a set of beams which is not based on the data processing model.

In some embodiments, the terminal device comprises circuitry configured to transmit the report to the network device by: in accordance with a determination of an occurrence of the inference failure, transmitting the report which comprises a non-acknowledgment (NACK) for all hybrid automatic repeat request-acknowledgment (HARQ-ACK) information bits.

In some embodiments, the terminal device comprises circuitry configured to transmit the report to the network device by: in accordance with a determination of an occurrence of the inference failure, transmitting the report comprising HARQ-ACK information bits on an uplink channel, wherein the uplink channel comprises an inference failure indicator.

In some embodiments, the terminal device comprises circuitry configured to in accordance with a determination of an occurrence of the inference failure, scrambling an uplink channel with an artificial intelligent (AI) or machine learning (ML) specific scramble sequence associated with the inference failure, wherein the report is transmitted on the uplink channel.

In some embodiments, the scrambling sequence is generated based on a radio network temporary identity (RNTI) for AI or ML, or wherein the scrambling sequence is an AI or ML specific pseudo-random sequence, or wherein the scrambling sequence is an AI or ML specific cyclic redundancy check (CRC) mask.

In some embodiments, a network device comprises circuitry configured to transmit, at a network device and to a terminal device, downlink information for triggering an report; and receive the report from the terminal device, wherein the report at least indicates whether an inference failure occurs in the data processing model.

In some embodiments, the network device comprises circuitry configured to receive the report from the terminal device by: in accordance with a determination of an occurrence of the inference failure, receiving the report from the terminal device, wherein a channel state information (CSI) field in the report is set to a predefined bit value, or a portion of the CSI field is set to the predefined bit value.

In some embodiments, the report comprises: the inference failure indicator and CSI corresponding to the inference failure indicator, and wherein the inference failure indicator indicates whether the inference failure occurs in the data processing model.

In some embodiments, the downlink information indicates that the report comprises an inference failure indicator.

In some embodiments, the report comprises a single part to indicate the inference failure indicator and the CSI.

In some embodiments, the report comprises a first part and a second part, wherein the first part comprises the inference failure indicator and the second part comprises the CSI corresponding to the inference failure indicator.

In some embodiments, the report comprises a first part and a second part, wherein the first part comprises at least one of: the inference failure indicator, a rank indication (RI), a CSI-reference signal (CSI-RS) resource indicator (CRI), a channel quality indicator (CQI), or an indication of the number of non-zero wideband amplitude coefficients per layer for a Type2 CSI, and the second part comprises a precoding matrix indicator (PMI); or wherein the report comprises a first part, a second part and a third part, wherein the first part comprises the inference failure indicator, the second part comprises at least one of: the RI, the CRI, the CQI, or the indication, and the third part comprises the PMI.

In some embodiments, the network device comprises circuitry configured to in accordance with a determination that the terminal device is configured with an enable parameter which enables the data processing model based CSI feedback, transmit, to the terminal device, a configuration indicating a type of a codebook. In some embodiments, the network device comprises circuitry configured to receive the report from the terminal device by: in accordance with a determination of an occurrence of the inference failure, receiving the report comprising the CSI feedback that is based on the codebook.

In some embodiments, the network device comprises circuitry configured to receive the report from the terminal device by: receiving the report from the terminal device, wherein the report comprises a bit field indicating the type of the codebook.

In some embodiments, the downlink information indicates a first time offset and a second time offset which is larger than the first time offset, or the downlink information indicates the first time offset and further downlink information indicates the second time offset.

In some embodiments, the network device comprises circuitry configured to receive the report from the terminal device by: in accordance with a determination that the inference failure does not occur in the data processing model, receiving the report from the terminal device according to the first time offset, wherein the report indicates a set of beams based on the data processing model and the second time offset is ignored.

In some embodiments, the network device comprises circuitry configured to receive the report from the terminal device by: in accordance with a determination of an occurrence of the inference failure, receiving the report from the terminal device according to the second time offset, wherein the report indicates a set of beams which is not based on the data processing model and the second time offset is ignored.

In some embodiments, the network device comprises circuitry configured to receive the report from the terminal device by: in accordance with a determination of an occurrence of the inference failure, receiving an inference failure indicator according to the first time offset; and receiving the report from the terminal device according to the second time offset, wherein the report indicates a set of beams which is not based on the data processing model.

In some embodiments, the network device comprises circuitry configured to receive the report from the terminal device by: in accordance with a determination of an occurrence of the inference failure, receiving the report which comprises a non-acknowledgment (NACK) for all hybrid automatic repeat request-acknowledgment (HARQ-ACK) information bits.

In some embodiments, the network device comprises circuitry configured to receive the report from the terminal device by: in accordance with a determination of an occurrence of the inference failure, receiving the report comprising HARQ-ACK information bits on an uplink channel, wherein the uplink channel comprises an inference failure indicator.

In some embodiments, the network device comprises circuitry configured to receive the report from the terminal device by: in accordance with a determination of an occurrence of the inference failure, receiving the report on an uplink channel, wherein the uplink channel is scrambled with an artificial intelligent (AI) or machine learning (ML) specific scrambling sequence associated with the inference failure.

In some embodiments, the scrambling sequence is generated based on a radio network temporary identity (RNTI) for AI or ML, or the scrambling sequence is an AI/ML specific pseudo-random sequence, or the scrambling sequence is an AI/ML specific mask.

FIG. 9 is a simplified block diagram of a device 900 that is suitable for implementing embodiments of the present disclosure. The device 900 can be considered as a further example implementation of the terminal device 110 as shown in FIG. 1. Accordingly, the device 900 can be implemented at or as at least a part of the terminal device 110. Alternatively, the device 900 can be considered as a further example implementation of the network device 120 as shown in FIG. 1. Accordingly, the device 900 can be implemented at or as at least a part of the network device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 920 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the CNB and a terminal device.

The program 930 is assumed to include program instructions that, when executed by the associated processor 910, enable the device 900 to operate in accordance with the embodiments of the present disclosure, as discussed herein with reference to FIGS. 2 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Ultra-reliable and Low Latency Communications (URLLC) devices, Internet of Everything (Iowa) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and Iota applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (Node or NB), an evolved Node (anode or eNB), a next generation Node (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1-38. (canceled)

39. A communication method, comprising:
receiving, at a terminal device and from a network device, downlink information for triggering a report;
determining, at the terminal device, whether an inference failure occurs in a data processing model; and
transmitting the report to the network device, wherein the report at least indicates whether the inference failure occurs in the data processing model.

40. The method of claim 39, wherein transmitting the report to the network device comprises:
in accordance with a determination of an occurrence of the inference failure, transmitting the report to the network device, wherein a channel state information (CSI) field in the report is set to a predefined bit value, or a portion of the CSI field is set to the predefined bit value.

41. The method of claim 39, wherein the report comprises at least one of: an inference failure indicator, or a CSI corresponding to the inference failure indicator, and
wherein the inference failure indicator indicates whether the inference failure occurs in the data processing model.

42. The method of claim 41, wherein the downlink information indicates whether the report comprises the inference failure indicator or not.

43. The method of claim 41, wherein the report comprises a single part, wherein the single part comprises at least one of the inference failure indicator and the CSI corresponding to the inference failure indicator.

44. The method of claim 41, wherein the report comprises a first part and a second part, wherein the first part comprises the inference failure indicator and the second part comprises the CSI corresponding to the inference failure indicator.

45. The method of claim 41, wherein the report comprises a first part and a second part, wherein the first part comprises at least one of: the inference failure indicator, a rank indication (RI), a CSI-reference signal (CSI-RS) resource indicator (CRI), a channel quality indicator (CQI), or an indication of the number of non-zero wideband amplitude coefficients per layer for a Type2 CSI, and the second part comprises a precoding matrix indicator (PMI).

46. The method of claim 41, wherein the report comprises a first part, a second part and a third part, wherein the first part comprises the inference failure indicator, the second part comprises at least one of: the RI, the CRI, the CQI, or the indication, and the third part comprises the PMI.

47. The method of claim 41, further comprising:
in accordance with a determination that the terminal device is configured with an enable parameter which enables the data processing model-based CSI feedback, receiving, from the network device, a configuration indicating a type of a codebook; and
wherein transmitting the report to the network device comprises:
in accordance with a determination of an occurrence of the inference failure, transmitting the report comprising the CSI that is based on the codebook.

48. The method of claim 41, further comprising:
determining a type of a codebook; and
wherein transmitting the report to the network device comprises:
transmitting the report to the network device, wherein the report comprises a bit field indicating the type of the codebook.

49. A communication method, comprising:
transmitting, at a network device and to a terminal device, downlink information for triggering an report; and
receiving the report from the terminal device, wherein the report at least indicates whether an inference failure occurs in the data processing model.

50. The method of claim 49, wherein receiving the report from the terminal device comprises:
in accordance with a determination of an occurrence of the inference failure, receiving the report from the terminal device, wherein a channel state information (CSI) field in the report is set to a predefined bit value, or a portion of the CSI field is set to the predefined bit value.

51. The method of claim 49, wherein the report comprises: the inference failure indicator and CSI corresponding to the inference failure indicator, and
wherein the inference failure indicator indicates whether the inference failure occurs in the data processing model.

52. The method of claim 51, wherein the downlink information indicates that the report comprises an inference failure indicator.

53. The method of claim 51, wherein the report comprises a single part to indicate the inference failure indicator and the CSI.

54. The method of claim 51, wherein the report comprises a first part and a second part, wherein the first part comprises the inference failure indicator and the second part comprises the CSI corresponding to the inference failure indicator.

55. The method of claim 51, wherein the report comprises a first part and a second part, wherein the first part comprises at least one of: the inference failure indicator, a rank indication (RI), a CSI-reference signal (CSI-RS) resource indicator (CRI), a channel quality indicator (CQI), or an indication of the number of non-zero wideband amplitude coefficients per layer for a Type2 CSI, and the second part comprises a precoding matrix indicator (PMI); or
wherein the report comprises a first part, a second part and a third part, wherein the first part comprises the inference failure indicator, the second part comprises at least one of: the RI, the CRI, the CQI, or the indication, and the third part comprises the PMI.

56. The method of claim 51, further comprising:
in accordance with a determination that the terminal device is configured with an enable parameter which enables the data processing model based CSI feedback, transmitting, to the terminal device, a configuration indicating a type of a codebook; and
wherein receiving the report from the terminal device comprises:
in accordance with a determination of an occurrence of the inference failure, receiving the report comprising the CSI feedback that is based on the codebook.

57. The method of claim 51, wherein receiving the report from the terminal device comprises:
receiving the report from the terminal device, wherein the report comprises a bit field indicating the type of the codebook.

58. A terminal device comprising:
a processor; and
a memory coupled to the processor and storing instructions thereon, the instructions, when executed by the processor, causing the terminal device to perform acts comprising the method according to claim 39.
